(19) United States
(12) Patent Application Publication
(10) Pub. No.: US 2005/0143155 A1
(43) Pub. Date: Jun. 30, 2005

(54) Physical activity apparatus

(76) Inventor: Philip John Baker, Sheffield (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/979,332

(22) Filed: Nov. 2, 2004

(30) Foreign Application Priority Data
Nov. 3, 2003 (GB) 0325572.6

(51) Int. Cl. G06F 17/00; G06F 19/00

(52) U.S. Cl. 463/7

(57) ABSTRACT

The invention relates to physical activity apparatus and has for its object the provision of apparatus that stimulates enjoyment and competitiveness and yet can be used by a single player. The objective is met by physical activity apparatus for playing a physical activity game comprising (i) projector unit capable of projecting one or more light beams onto a planar, upright surface such as a wall; (ii) signal unit(s) adapted to be held or worn by a player and with which a player attempts to intercept a light beam; (iii) means to cause the direction of the one or more light beams to change; and (iv) means to limit the maximum extent of horizontal and vertical movement of the one or more light beams.

This invention relates to physical activity apparatus for playing a physical activity game which is physically demanding, can readily be played in the home by only one player, and yet contains elements of skill, chance and competitiveness.

Most forms of exercise which can be performed in the house and alone are tedious. Many people need the stimulation of enjoyment and/or competitiveness to push themselves to the extent necessary to achieve increased fitness. The following is aimed at the large body of people who recognise the need for exercise, but whose energy drains away at the thought of jogging, rowing machinery, exercise bikes etc.

According to a first aspect of the present invention physical activity apparatus for playing a physical activity game, comprises:—
(i) projector unit capable of projecting one or more light beams onto a planar, upright surface such as a wall;
(ii) a timing device(s) to define the length of a game and rest and activity periods within the game; and
(iii) a signal unit(s) adapted to be held or worn by a player and with which a player attempts to intercept a light beam.

According to a second aspect of the present invention there is provided physical activity apparatus for playing a physical activity game, comprising:
(i) projector unit capable of projecting one or more light beams onto a planar, upright surface such as a wall;
(ii) signal unit(s) adapted to be held or worn by a player and with which a player attempts to intercept a light beam;
(iii) means to cause the direction of the one or more light beams to change; and
(iv) means to limit the maximum extent of horizontal and vertical movement of the one or more light beams.

The means to define the length of a game may be by way of one or more timing devices that may also define rest and activity periods. Equally, the means could be a counter to count the number of interceptions up to a predetermined number.

The projector unit preferably serves automatically to direct the light beam(s) randomly, or in a predetermined manner within controllable parameters, such as the size of the wall onto which the light beam(s) is to be projected, while the light beam(s) is/are also preferably switched on and off, and/or triggered to change direction by the projection unit under the control of a signal, such as an infrared signal. The apparatus preferably also includes a means of calculating and displaying data such as a score and possibly also recording highest score etc. Also, the apparatus preferably includes audible sound emitting means. Any data calculating and display means, and any audible sound emitting means are also preferably contained within the projector unit.

The beam of light may be generated by a laser light source, and the beam of light directed at the said surface passed through a lens to give it a divergent character and appear on the said surface as an easily seen spot of light. Control over the direction of the light beam may be by way of a combination of motorised mirrors. Alternatively, the light source may be a light emitting diode with controlled pivotal movement in the vertical and horizontal direction by way of appropriate motors.

To provide control over the apparatus at large and the motors of the mirrors or the light emitting diode in particular, microprocessor means may be provided in the projector unit, with software that can be set to determine the maximum vertical and horizontal movement of the spot of light on the said surface, and cause the random or predetermined movement of that spot by causing a random or predetermined driving of the motorised mirrors or the motors of the light emitting diode, as a reaction to the light beam having been intercepted.

To enable this, the signal units held or worn by a player may have a light sensitive area, to sense that the light beam has been intercepted, and the signal unit may incorporate an infrared signal emitter, to direct a signal to an infrared receiver on the projector unit, to cause the random or predetermined movement of the light bean and hence the spot of light.

The signal unit used may take the form of a bat or racket to be held in the hand or may be a device strapped to the hand of a player. In its simplest form, one beam of light is required, but more complex games can be provided for by providing more than one light beam. The projector unit can take a form which can be affixed to a wall, permanently or semi-permanently.

In use, the projector unit and signal unit are switched on. The player positions himself close to and facing the wall selected as the field of play with the projector unit behind him. After notifying the player that the game is about to commence by means of an audible signal, the projector unit projects a beam of light onto the field of play. Guided by the spot of light which has been created on the wall, the player moves to intercept the light beam with the signal unit which, when he is successful emits an infrared signal causing the projector to move the light beam to a different area of the wall. The player again moves to intercept the light beam upon which the light beam again moves to a different area and so on. Audible signals are provided to indicate successful interceptions and when re-positioning of light beams has been effected.

Some advantages of the apparatus in accordance with the invention are that:
(i) the apparatus can be used where space is limited, requiring only a clear strip of ⅔ feet from a wall which could be a window wall;
(ii) once set up, the apparatus can be left in position and ready for use, being unobtrusive. Alternatively the apparatus can be made totally portable;
(iii) the apparatus, and consequently the game develops not only fitness but balance, coordination etc;
(iv) the apparatus is capable of mass production; and
(v) the apparatus is capable of repeat sales with the development of new games.

Two embodiments of the invention will now be described with reference to the accompanying drawings, in which:—

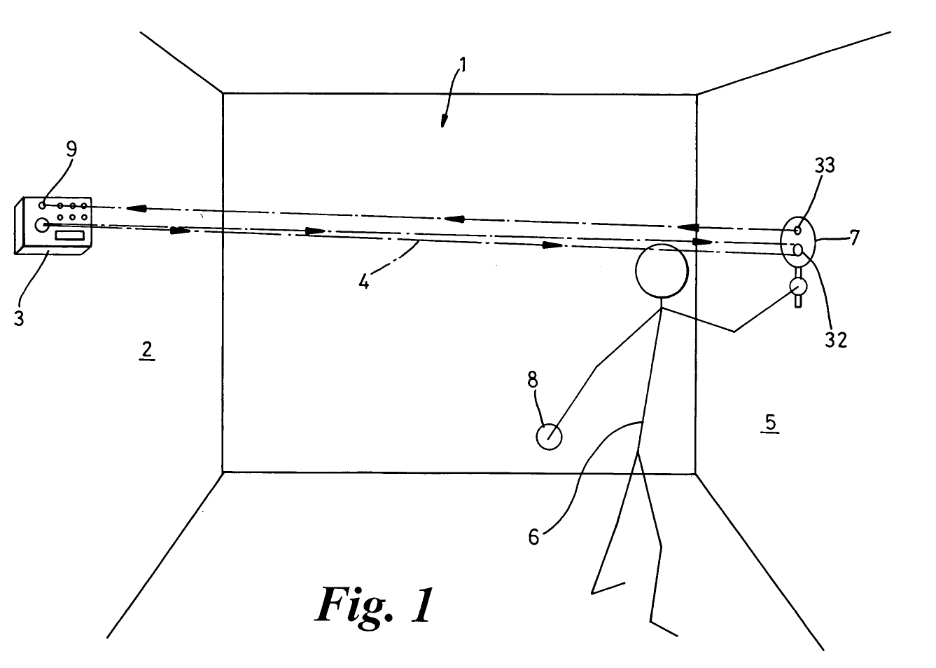

FIG. 1 is a schematic view of physical activity apparatus according to the invention;

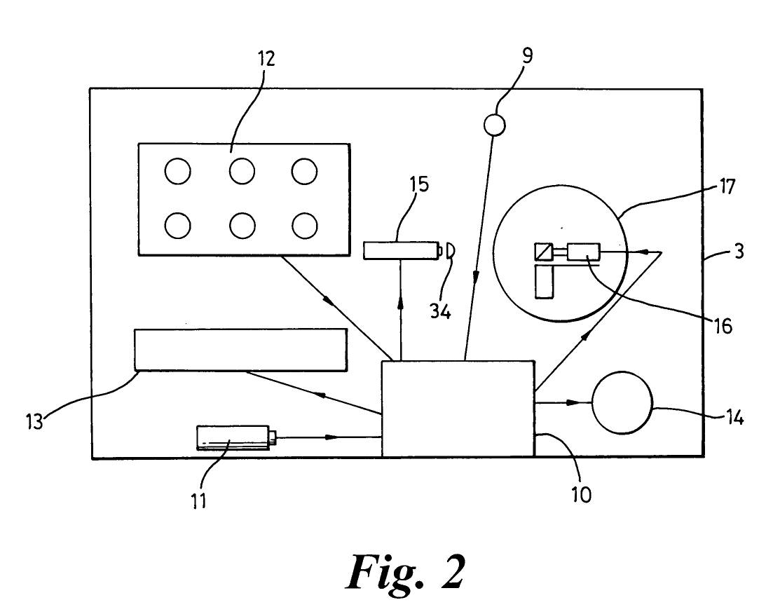

FIG. 2 is a schematic general arrangement drawing of a projection unit for use in the apparatus of FIG. 1;

FIG. 3 is a schematic side elevation of a control means over a laser beam for use in the apparatus of FIG. 1;

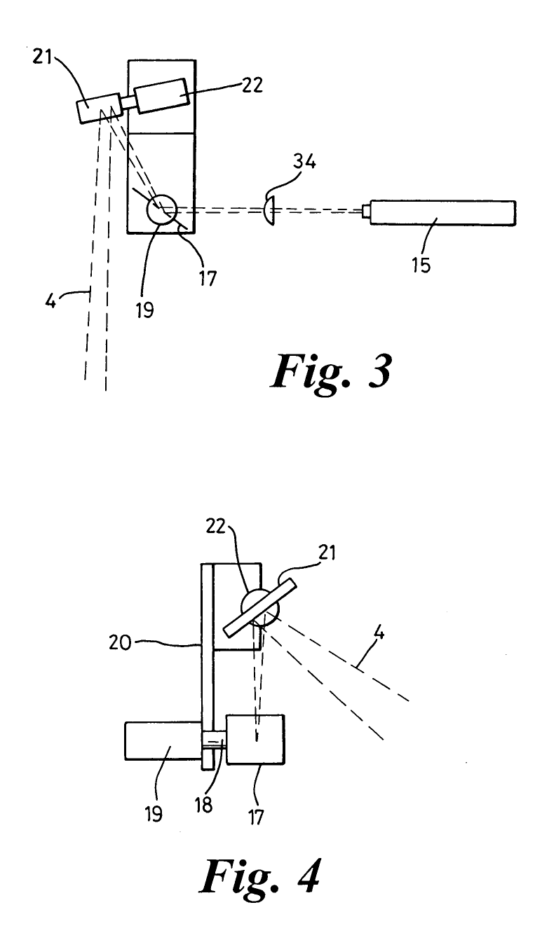

FIG. 4 is a schematic end elevation of FIG. 3;

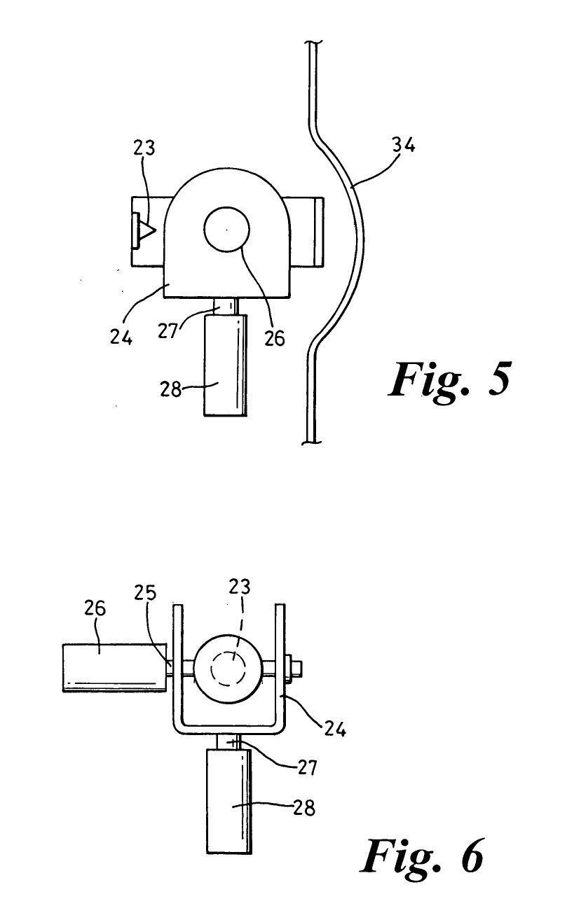

FIG. 5 is a schematic side elevation of a control means over a beam from a light emitting diode for use in the apparatus of FIG. 1;

FIG. 6 is a side elevation of FIG. 5;

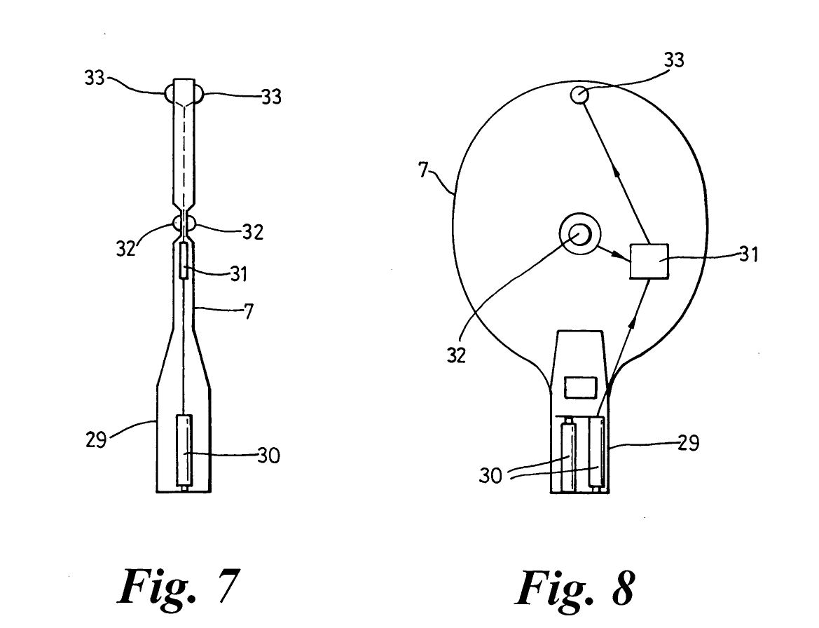

FIG. 7 is a schematic side elevation of a signal unit for use in the apparatus of FIG. 1; and

FIG. 8 is a schematic front elevation of the signal unit of FIG. 5.

In FIG. 1, there is depicted in schematic manner an area 1 where the physical activity apparatus of the invention is illustrated. The area 1 can be for example a room in a domestic dwelling or a dedicated room/area of such as a sports facility. On one wall 2 is mounted a projector 3 to project a beam 4 of light towards a second wall 5. The beam 4 creates a spot of light on the wall 5, and a player 6 moves, using the spot of light as a reference point, to intercept the beam 4 by a signal means 7 held by the hand of the player 6. In the alternative, a signal means 8 could be attached to the hand of the player 6 such as by straps.

When the beam 4 is intercepted, the signal means emits a signal back to the projector unit 3 received by an infrared receiver 9 to cause the direction of the beam 4 of light to change when the player 6 must move again to intercept the beam.

As is indicated by FIG. 2, the projector unit 3 has a microprocessor 10 to receive a signal from the infrared receiver 9, powered by batteries 11, and a control panel 12 to serve as a main ON/OFF switch, the control panel also providing a separate switch for a liquid crystal display 13 to indicated a players score, and a speaker 14 to emit an audible signal each time a player successfully intercepts the light beam 4. At the onset of the activity, a player can determine the size of the area of the wall 5 where a light spot can appear, by using the control panel 12 to signal software on the microprocessor 10 to set limits on the permitted horizontal and vertical movement of the light beam 4.

As is indicated in FIG. 2, the light beam 4 can be generated by a laser light source 15, the direction of which is determined by a system of motorised mirrors 16 to direct the beam 4 through an aperture 17 in the front wall of the projector unit 3. In the alternative the laser 15 and motorised mirrors 16 can be replaced by a light emitting diode and drive motors to alter its orientation, as is discussed below.

In FIGS. 3 and 4 is a schematic representation of the employment of a laser as the source of the beam 4 of light. Here, the laser light source 15 directs its beam to a first mirror 17 provided on the shaft 18 of a motor 19 mounted in the control unit on a support 20, power to the motor 19 being via the microprocessor 10. Also mounted on the support 20 is a second mirror 21 and a drive motor 22 also powered via the microprocessor 10. After using the control panel 12 to provide information to software in the microprocessor 10 to impose limits on the movement of the light beam 4, the physical activity apparatus is switched on to create a light spot on the wall 5. When the player 6 intercepts the light beam 4, the signal means 7 emits an infrared signal picked up by the infrared receiver 9, that in turn feeds a signal to software in the microprocessor 10 to cause both of the motors 19 and 22 to be driven in random or predetermined manner within the limits imposed by the software, to re-set the mirrors 17 and 21 to direct the light beam 4 to a different point on the wall 5, when the player must move to intercept the light beam in its new direction.

In the alternative arrangement schematically illustrated in FIG. 5, the laser and motorised mirrors of FIGS. 3 and 4 can be replaced by a light emitting diode 23 mounted in the projector unit 3 in a yoke 24 on a shaft 25 of a motor 26, the shaft serving as a point axis for the diode. The yoke 24 is mounted on the shaft 27 of a motor 28. Both of the motors are powered via and controlled by the software in the microprocessor 10.

Thus, and in common with FIGS. 3 and 4, the software can first be set to limit the maximum permitted movement of the diode about its two axes, and limit the maximum permitted movement of the emitted light beam in the horizontal and vertical directions. Once the light beam has been activated to create a spot of light on the wall 5, the player again intercepts the beam, to cause an infrared signal to be emitted and received by the infrared receiver 9, with a signal then being generated and sent to the software in the microprocessor that in turn signals the motors 26 and 28 to be driven in random or predetermined manner to a new position, the player then moving to intercept the light beam in its new direction.

The control panel can serve the additional purpose of setting a maximum time for a player to exercise, and can be by having a counter to count the number of successful interceptions, or can be a timer to set the time during which the apparatus is active.

Equally, the control panel can be used to set the speed at which the light beam direction is changed, to accommodate players of different ages and dfferent levels of fitness.

As is illustrated schematically in FIGS. 7 and 8, signal means take the form of a bat or racket 7 with a handle 29 housing batteries 30. The batteries provide power to a control circuit 31 connected to light sensitive cells 32 and an infrared signal emitter 33. As the bat or racket intercepts the light beam 4, the light sensitive cells 32 emit a signal to the control circuit 31 that in turn emits a signal to the infrared emitter 33 to cause an infrared emission to be directed at the infrared receiver 9 on the projection unit 3.

To ensure that the light spot appearing on the wall is sufficiently visible, a lens 34 is provided in the light path from the laser 15 or the light emitting diode 23, to cause a divergent beam of light 4.

1. Physical activity apparatus for playing a physical activity game, comprising:—
(i) projector unit capable of projecting one or more light beams onto a planar, upright surface such as a wall;
(ii) a timing device(s) to define the length of a game and rest and activity periods within the game; and
(iii) a signal unit(s) adapted to be held or worn by a player and with which a player attempts to intercept a light beam.

2. Physical activity apparatus for playing a physical activity game, comprising
(i) projector unit capable of projecting one or more light beams onto a planar, upright surface such as a wall;
(ii) signal unit(s) adapted to be held or worn by a player and with which a player attempts to intercept a light beam;
(iii) means to cause the direction of the one or more light beams to change; and
(iv) means to limit the maximum extent of horizontal and vertical movement of the one or more light beams.

3. Physical activity apparatus as in claim 1 wherein the means to define the length of a game is one or more timing devices.

4. Physical activity apparatus as in claim 1 wherein the means to define the length of a game is one or more counters to count the number of interceptions.

5. Physical activity apparatus as in claim 3 wherein the timing device(s) time activity and rest periods.

6. Physical activity apparatus as in claim 1 or claim 2 wherein the projector unit serves automatically to direct the light beam(s) randomly, or in a predetermined manner within controllable parameters.

7. Physical activity apparatus as in claim 6, wherein the random or predetermined direction of the light beam(s) by the projector is provided by a control unit triggered by a signal transmitted by the signal unit(s) held or worn by the player.

8. Physical activity apparatus as in claim 7 wherein the control unit has an associated microprocessor with software to determine the changes in direction of the light beam(s).

9. Physical activity apparatus as in claim 7 or claim 8 wherein the light source for the light beam(s) is one or more laser light sources.

10. Physical activity apparatus as in claim 9 wherein the laser light source has at least one associated mirror that projects a light beam, the mirror having associated drive motor means to alter its angular disposition.

11. Physical activity apparatus as in claim 9 wherein the laser light source has at least two associated mirrors that combine to project a light beam, each mirror having an associated drive motor to alter its angular disposition.

12. Physical activity apparatus as in claim 7 or claim 8 wherein the light source for the light beam(s) is one or more light emitting diodes.

13. Physical activity apparatus as in claim 12 wherein each light emitting diode is mounted for angular movement in the horizontal and vertical directions by drive motors.

14. Physical activity apparatus as in claim 13 wherein the light emitting diode is mounted on the spindle of one motor, the spindle being mounted for rotation on the arms of a yoke, and the yoke being mounted on the spindle of a second motor.

15. Physical activity apparatus as in claim 1 or claim 2 wherein the signal means is a bat-like device to be held by the player, the bat having a light sensitive area to sense the interception of a light beam, and a signal emitter triggered by the sensing of the interception of the light beam.

16. Physical activity apparatus as in claim 1 or claim 2 wherein the signal means is a pad to be secured to the player, the pad having a light sensitive area to sense the interception of a light beam, and a signal emitter triggered by the sensing of the interception of the light beam.

17. Physical activity apparatus as in any of claims 1 to 16 wherein a means of calculating and displaying data related to the performance of the player is provided.

18. Physical activity apparatus as in any of claims 1 to 17 wherein audible means are provided to indicate to the player a successful interception of a light beam.

19. Physical activity apparatus as in any of claims 1 to 18, wherein the light beam is caused to be divergent by passing it through a lens.

20. Physical activity apparatus substantially as hereinbefore described with reference to the accompanying drawings.
